(19) United States
(12) Patent Application Publication
(10) Pub. No.: US 2015/0065215 A1
(43) Pub. Date: Mar. 5, 2015

(54) SYSTEM AND METHOD FOR OPTIMIZING ALLOCATION OF RESOURCES IN ELECTRONIC GAMES

(71) Applicant: Avaya Inc., Basking Ridge, NJ (US)

(72) Inventor: Neil O'Connor, Galway (IE)

(73) Assignee: Avaya Inc., Basking Ridge, NJ (US)

(21) Appl. No.: 14/016,173

(22) Filed: Sep. 2, 2013

(51) Int. Cl. A63F 13/00

(52) U.S. Cl. CPC A63F 13/00
USPC 463/9

(57) ABSTRACT

A resource allocation system for optimizing the allocation of resources in electronic games is provided. The resource allocation system includes a consumer attribute collection module configured to collect one or more consumer attributes associated with a consumer of an electronic game. The resource allocation system includes a consumer profile compilation module configured to describe the consumer by the one or more consumer attributes to produce a consumer profile. The resource allocation system includes a resource allocation module configured to allocate a resource of the electronic game to the consumer based on the consumer profile and one or more strategy rules.

### BACKGROUND

1. Field of the Invention

Embodiments of the present invention provide a system and a method for optimizing allocation of resources to a consumer. More particularly, embodiments of the present invention provide a system and a method for allocating resources consumed in an electronic game.

2. Description of Related Art

Electronic game providers often market “resources” to consumers of the electronic game (e.g., the gamer). Various types of resources are marketed, such as, for example, extended playtime, in game ability upgrades, in game items, additional playable characters and/or areas, and removal of ads.

Often, electronic game providers offer these resources for purchase to the consumer as a method of monetizing the electronic game. This may be especially true in the case where a version of the electronic game is offered for free. For example, many electronic games are offered for free through various “marketplaces” (e.g., Amazon™ AppStore, Apple™ App Store, Google™ Play Store, Blackberry™ Market, Microsoft™ Market Place, Playstation™ PlayStore, XBOX™ Store, or the like). The providers (e.g., developers, marketers, proprietors, or the like) of these electronic games then seek to monetize the game by offering resources for purchase. The resources typically may be purchased either through an in-game interface or as an add-on purchased from the marketplaces. Even electronic games that must initially be purchased often at some time (e.g., coinciding with the initial release and/or following an initial release of the game) have associated resources that may be purchased to enhance the game play experience.

Conventionally, electronic game providers offer these resources based on various static considerations. For example, the resources offered may be based on the “level” of the consumer's in-game character. As another example, some games grant the consumer credits (e.g., sometimes referred to as coins, points, rewards, or the like) for accomplishing certain objectives. The consumer may also be able to purchase credits. These credits then are used in game to “unlock” resources. As another example, some electronic game providers simply offer the same resources to all players.

As will be appreciated, offering these resources based on static considerations alone may not facilitate maximizing the revenue generated from these resources (e.g., in the form of ad revenue and/or resource purchase revenue).

Therefore, there is a need for a system and method that is capable of allocating resources to consumers of electronic games based on both static and dynamic considerations, and further, which facilitates an increase in the monetization potential of resources offered to consumers of electronic games.

### SUMMARY

Embodiments in accordance with the present invention provide a resource allocation system for optimizing the allocation of resources in electronic games. The resource allocation system includes a consumer attribute collection module configured to collect one or more consumer attributes associated with a consumer of an electronic game. The resource allocation system further includes a consumer profile compilation module configured to describe the consumer by the one or more consumer attributes to produce a consumer profile. The resource allocation system further includes a resource allocation module configured to allocate a resource of the electronic game to the consumer based on the consumer profile and one or more strategy rules.

Embodiments in accordance with the present invention further provide a computer-implemented method for allocating resources for electronic games. The computer-implemented method comprises collecting one or more consumer attributes associated with a consumer of an electronic game. The computer-implemented method further comprises generating a consumer profile of the consumer based on the one or more consumer attributes. The computer-implemented method further comprises allocating a resource of the electronic game to the consumer based on the consumer profile and one or more strategy rules.

Embodiments in accordance with the present invention further provide a computer readable medium storing computer readable instructions that when executed by a processor performs a method. The method comprises collecting one or more consumer attributes associated with a consumer of an electronic game. The method further comprises generating a consumer profile of the consumer based on the one or more consumer attributes. The method further comprises allocating a resource of the electronic game to the consumer based on the consumer profile and one or more strategy rules.

Further, the present invention can provide a number of advantages depending on its particular configuration. First, the present invention provides for allocating resources based on a strategy, such as, maximizing revenue and/or advertisement views. Second, the present invention provides for optimizing resource allocation for multiple resources and/or multiple electronic games. Third, the present invention provides for allocating resources to a consumer based on both static and dynamic information about the consumer and/or the electronic game.

These and other advantages will be apparent from the disclosure of the present invention contained herein.

The preceding is a simplified summary of the present invention to provide an understanding of some aspects of the present invention. This summary is neither an extensive nor exhaustive overview of the present invention and its various embodiments. It is intended neither to identify key or critical elements of the present invention nor to delineate the scope of the present invention but to present selected concepts of the present invention in a simplified form as an introduction to the more detailed description presented below. As will be appreciated, other embodiments of the present invention are possible, utilizing one or more of the features set forth above or described in detail below.

### BRIEF DESCRIPTION OF THE DRAWINGS

The above and still further features and advantages of the present invention will become apparent upon consideration of the following detailed description of embodiments thereof, especially when taken in conjunction with the accompanying drawings, and wherein:

FIG. 1 is a block diagram depicting an electronic game environment according to an embodiment of the present invention;

FIG. 2 is a block diagram of a computing device according to an embodiment of the present invention;

FIG. 3 is a block diagram of a server according to an embodiment of the present invention; and

FIG. 4 is a flowchart of a method for allocating resources in an electronic game, in accordance with an embodiment of the present invention.

The headings used herein are for organizational purposes only and are not meant toused to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

### DETAILED DESCRIPTION

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read.

A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the present invention is considered to include a tangible storage medium or distribution medium and prior art-recognized equivalents and successor media, in which the software implementations of the present invention are stored.

The terms “determine”, “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the present invention is described in terms of exemplary embodiments, it should be appreciated those individual aspects of the present invention can be separately claimed.

The term “computer”, “computing device”, or “server” as used herein should be understood to include desktop computers, laptop computers, Ultrabook™ computers, tablet computers, smartphones, handheld computing devices, portable game systems, “console” style game systems, “arcade” style game systems, as well as any processor-based computing device.

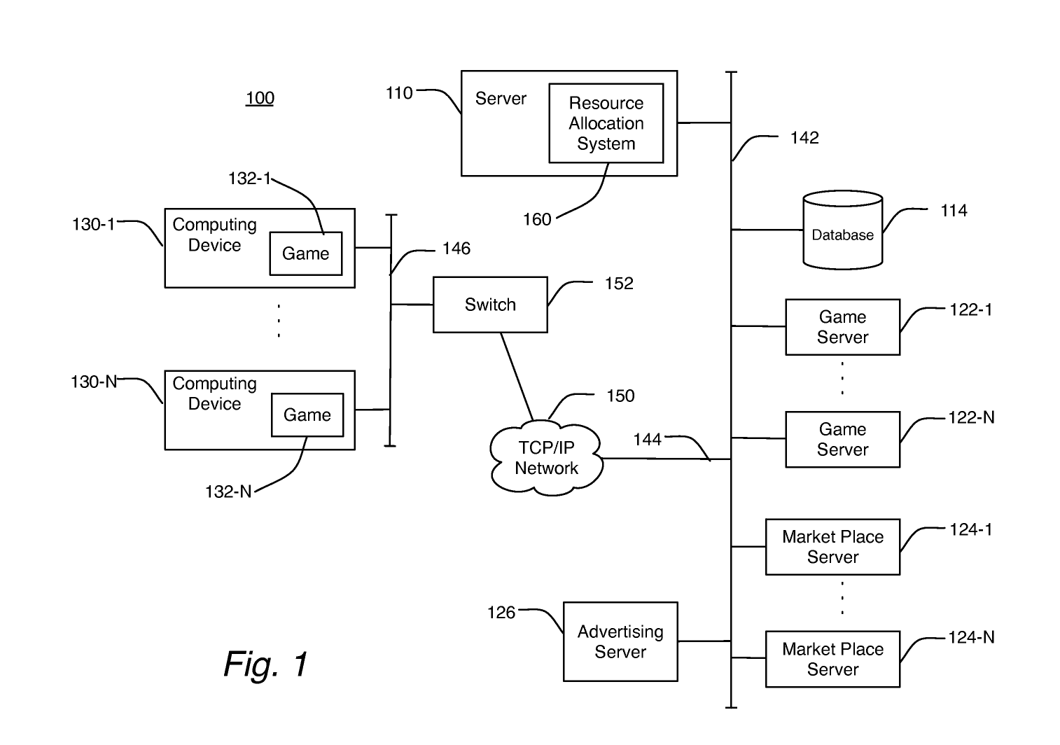

FIG. 1 shows an illustrative embodiment of the present invention. An electronic game environment 100 comprises a resource allocation server 110, a set of data stores or databases 114 containing consumer and resource related information and other information that can enhance the value and efficiency of the resource allocation processing, and a plurality of servers, namely game servers 122-1 to N, market place servers 124-1 to N, and an advertising server 126, a plurality of computing devices 130-1 to N (i.e., devices used by a consumer to play an electronic game), all interconnected by a communication network 142 that may be a local area network (LAN), a wide area network (WAN), or the Internet, all of which are generically referred to herein as WAN 142. The servers can be connected via communication lines 144 to a TCP/IP Network 150. The computing devices can be connected via communication lines 146 to the switch 152. The network 150 is connected via switch 152 to process communication passing between the servers and the computing devices 130.

The computing devices 130 are network connectable and can generally include any of the computing devices as defined above. In more specific examples, the computing devices 130 can include a tablet computer, a smart phone, a console video game system, or a portable video game system.

The network 150 can be any data and/or distributed processing network, such as the Internet. The network 150 typically includes proxies (not shown), registrars (not shown), and routers (not shown) for managing data flow.

The switch 152 can be any network connection interface, router, and/or modem configured to provide data processing between the computing devices 130 and the network 150. For example, the switch 152 may be a cable modem, a DSL modem, a wired or wireless router, or a wireless data access point (e.g., a 3G or 4G wireless data access point, or the like).

It should be noted the present invention does not require any particular type of information transport medium between modem or server and computing devices, i.e., the present invention may be implemented with any desired type of transport medium as well as combinations of different types of transport channels.

It should be emphasized the configuration of the switch, server, user communication devices, and other elements as shown in FIG. 1 is for purposes of illustration only and should not be construed as limiting the present invention to any particular arrangement of elements.

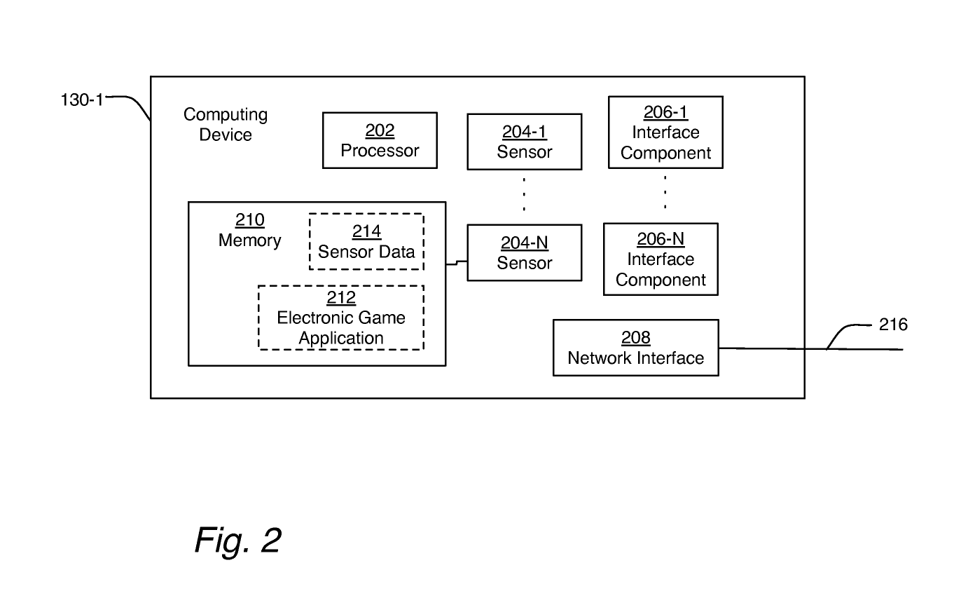

Further as shown in FIG. 1, the computing devices 130 (configuration of which is explained further in conjunction with FIG. 2) comprise an electronic game 132-1 to 132-N as an embodiment of the present invention. In general, the electronic games 132 may be any type of game “playable” via a computing device. For example, the electronic games 132 can be a game downloaded from one of the market place servers 124, downloaded from one of the game servers 122, and/or installed on the computing device 130.

In some examples, the electronic games 132 may be a single player game, a multi-player game, or a massively multiple online role-playing game. In some examples, the electronic games 132 may transmit and/or receive data to/from the game servers 122 as part of the game play experience. Furthermore, in some examples, the electronic games 132 may be different. For example, the first electronic game 132-1 may be a particular electronic game while the second electronic game 132-2 may be a different particular electronic game.

The electronic games include the ability to acquire various resources that may be used in the game. For example, the electronic games 132 may include a game where players drive vehicles around a course and race computer and/or other players. The resources may be upgrades to a player's car, such as, for example, tires, engine modifications, suspension modifications, or the like.

As another example, the electronic games 132 may include a first-person shooting game, where players engage in combat with computer and/or other players. The resources may be additional and/or upgraded weapons (e.g., larger caliber, increased magazine capacity, incased firing rate, increased accuracy, or the like). The resources may be additional armor, health regeneration characteristics, or increased abilities (e.g., movement speed, jumping ability, or the like).

As another example, the electronic games 132 may include a trivia game where players answer questions and may compete against other players for high scores, etc. The resources may be hints to the answer, the ability to select a category for the trivia questions, access to experts to assist in answering the questions, or the like.

As a still different example, the electronic games 132 may include simulation games, where environments are simulated (e.g., building a farm). The resources may be materials to build structures and/or items in the simulation, technology and/or knowhow to build resources in the simulation, increased rates of building, growth, and/or development of the simulation, or the like.

In some examples, the electronic games 132 may present (e.g., using a display, an audio source, or the like) various advertisements to the consumer (i.e., user of the computing devices 130). The advertisements may be generated, and/or processed by the advertising server 126. Thus, the resources can be the ability to turn of advertisements, select a preferred category and/or delivery method for advertisements, or pause advertisements for a period of time.

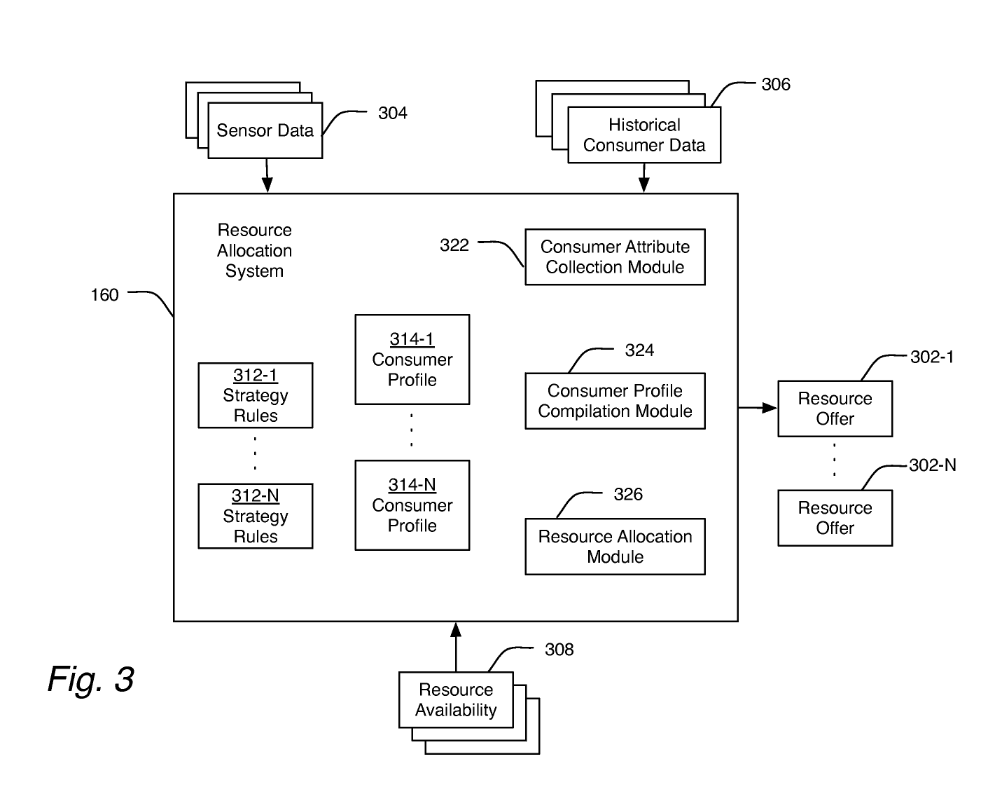

Further, as shown in FIG. 1, the resource allocation server 110 comprises a resource allocation system 160 (the configuration of which is explained in greater detail below in conjunction with FIG. 3) as an embodiment of the present invention. In general, the resource allocation system 160 allocates the resources in the environment 100. More specifically, the resource allocation system 160 allocates what resources and at what cost, will be allocated to which consumers. The resource allocation system 160 uses information regarding the availability of resources and also information about the consumers (e.g., information received from the computing devices 130 (refer to FIGS. 2 and 3) and/or information from the database 114) to determine the allocation.

FIG. 2 illustrates an embodiment of computing device 130-1. It is to be appreciated the computing devices 130-2 to N can have similar component to those illustrated in FIG. 2. The computing device 130-1, however, is described for illustrative purposes only and is not intended to be limiting. As such, the environment 100 can have computing devices 130 with a different configuration than that shown in FIG. 2. As depicted, the computing device 130-1 includes a processor 202, a plurality of sensors 204-1 to N, a plurality of interface components 206-1 to N, a network interface component 208, and a memory 210.

The computing device 130-1 is shown in communication with a communication line 216, which can be a data transmission line, such as communication lines 146. The network interface 208 may provide the communication structure for processing data between the computing device 130-1 and the servers in the system 100. For example, the network interface 208 may be an Ethernet interface, a Wi-Fi interface, a 3G interface, a 4G, interface, Bluetooth™ or generally, any interface capable of communicating with the network 150.

The memory 210 can be any type of memory configured to store computer readable instructions and/or data. In preferred embodiments, the memory can be a computer-readable medium as defined above. As depicted, the memory 210 may include an electronic game application 212 and sensor data 214. In general, the electronic game application 212 can be any type of application where resources may be offered to the consumer (i.e., user of the computing device 130-1).

In some examples, the electronic game application 212 may be computer executable instructions, executable by the processor, which when executed, allow a consumer to “play” the electronic game (e.g., the electronic game 132-1) using the computing device 130-1. The electronic game may be “played” using the interface components 206. In general, the interface components may be any input and/or output devices with which the consumer may interact with the computing device. In some examples, the interface components may be a display, a speaker, a microphone, a keyboard, a mouse, a touch screen, a directional pad, a joystick, a hardware button, a virtual button, a haptic feedback component, or the like.

In order to assist in the allocation of resources (refer to FIG. 3), the computing devices 130 may include sensors 206 for collecting various static and dynamic metrics regarding the electronic game and/or the consumer. These collected metrics are stored as sensor data 214. The sensors 206 may collect, for example, metrics such as, location, time of day, physical movement, ambient temperature, or the like. In some examples, the sensors 206 may include a GPS sensor, an accelerometer, a thermometer, a timer, or a camera.

In some examples, the sensor data 214 may be referred to as “real-time” data as it may correspond to particular metrics representing the consumer's current status and/or environment (e.g., current location, current temperature at location of play, or the like).

FIG. 3 illustrates an embodiment of the resource allocation system 160. As depicted, the system 160 is configured to determine resource offers 302-1 to N, which correspond to resources to be offered to the consumers of electronic games based on sensor data 304, historical consumer data 306, and resource availability 308. As described herein, the available resources are allocated to the consumers based on static and dynamic information. The system 160 includes a consumer attribute collection module 32, a consumer profile compilation module 324, a resource allocation module 326, and a resource delivery module 328.

As described above, various resources may be offered to consumers of electronic games. For example, the consumers (e.g., players) of the electronic games 132-1 to N may be offered different resources depending upon the particular electronic game being played. The resource availability 308 corresponds to the resources that may be offered to consumers playing the electronic game.

In some embodiments, the resource availability 308 may be specified in terms of the number of available resources per time period. For example, the resource availability may state that for a given electronic game, the ability to run twice as fast may be given away 50 times in an hour. As another example, the resource availability may state that for a different given electronic game, a hint for how to complete a particular level may be given away 20 times in 30 minutes.

As will be appreciated, as the resources are often virtual (e.g., electronic) they may be technically unlimited in nature. The system 160, however, may artificially restrict (e.g., by the resource availability 308) these resources in order to preserve a particular quality of the game and/or in order to apply a particular resource allocation strategy.

As the resources are thus limited, the resource allocation system 160 allocates the resources defined by the resource availability 308 to consumers based on the sensor data 304 and/or the historical consumer data 306. The consumer attributes collection module may be configured to receive the sensor data and/or the historical consumer data. As described above, the computing devices 130 may be configured to collect metrics regarding the electronic game and/or the consumer. These metrics can be represented by sensor data (e.g., the sensor data 214) collected from computing devices associated with the consumer. In some examples, the server 110 receives the sensor data from the computing devices 130 via network 150.

The historical consumer data 306 may include information about the consumer's play habits. For example, the historical consumer data 306 may include the high score achieved by the consumer, average length of play per session, frequency of play, distribution of play in period (e.g., week, month, year), and/or “proficiency of play.”

In general, the “proficiency of play” is a measure of the player's proficiency or skill. For example in some games the number of “kills” is important, while in others it might be the number of healthy farm animals being tended, while in others it might be coins/awards amassed or distance traveled. As such, the proficiency of play measure may correspond to these numbers (e.g., kills, healthy farm animals, coins/awards amassed, distance traveled, etc.) Furthermore, the proficiency of play may include more than one dimension. For example, an objective might be to maintain the happiness of a virtual character in the game, while also conducting transactions of value (e.g., bartering game assets, etc.) with other online human players. As such, a proficiency of play may correspond to both the happiness of a virtual player as well as the success of bartering game assets (e.g., number of transactions, value of transactions, etc.)

The system 160 may be configured to combine the sensor data 304 and the historical data 306 to form a consumer profile 314-1 to N for each consumer in the system 100. The consumer profile compilation module 324 may be configured to generate the consumer profiles 314. The consumer profile 314 may be a representation of the information from the senor data 304, the historical data 306, and/or other information that may be received from the electronic game. For example, the consumer's current level and/or score may be received from the electronic game and added to the consumer profile 314. As another example, the consumer's credit balance may be added to the consumer profile 314. Still, in another example, the amount of time played for the current session may be added to the consumer profile 314.

The system 160 then generates resource offers 302-1 to N from the consumer profiles 314 based on strategy rules 312-1 to N. The resource allocation module 326 may be configured to determine the allocation of resources and generate the resource offers 302. It is important to note, the number of resource offers generated may not equal the number of consumer profiles. More specifically, in some examples not all consumers will be offered a resource. With some examples, a single consumer may be offered more than one resource. In some examples, the same resource may be offered to multiple consumers, but at different costs or prices. This may be determined by the current status or historical profile of the consumer.

In general, each of the resource offers 302 may include the resource to be offered, the consumer to be offered the resource, and a cost associated with the offer. In some examples, the cost may be free (e.g., have a price equal to zero). In some examples, the cost may be greater than zero and reflected in the consumer's local currency. In some examples, the cost may be greater than zero and reflected in the credits of the corresponding electronic game. In some examples, the cost may be that the consumer views a particular advertisement.

The resource offers 302 are generated based on strategy rules 312. In general, the strategy rules 312 are adaptable and/or stackable rule based algorithms that define particular objectives with respect to allocating the resources. Said differently, the strategy rules 312 define how resources are to be allocated using rule based decisions. The strategy rules 312 may vary from game to game. Accordingly, resource offers 302 may be generated based on different strategy rules 312 for each game managed by the server 110. For example, a first game may have a corresponding strategy that optimizes play time (e.g., as the first game has recently been added to the free game store, or another reasons). As such, the strategy rules 312 selected to generate resource offer 302 for the first game may de-emphasize proficiency when deciding what incentives to offer. A second game may have a corresponding strategy that rewards long time players (e.g., as the game has been playable for a specified period of time, or another reasons.) Therefore proficiency is deemed important in in the strategy rules 312 selected to generate resource offers 302 (i.e. with the intent to rewards players who are supporters of the second game.)

In some examples, the strategy rules 312 may be applied similarly to each particular electronic game 132. In some examples, the electronic games 132 may have different sets of strategy rules 312 that are applied to the resources for each respective electronic game. In some examples, the strategy may be different for each consumer and/or for the same consumer but at different times of play. More particularly the strategy for a particular electronic game may be different depending upon the consumer's level, average play time, location and time of play, frequency of play time, experience, credits, or the like.

In some examples, the strategy can be to maximize revenue (e.g., actual resource purchases and/or advertising revenue). In some examples, the strategy can be to maximize playtime for each consumer. In some examples, the strategy can be to maximize advertisement views. In some examples, the strategy may be to maximize revenue for players having an average playtime above a selected threshold and maximize playtime for players having an average playtime below a selected threshold.

In some examples, the strategy may be to maximize revenue for players having total playtime above a selected threshold and maximize playtime for players having a total playtime below a selected threshold. In some examples, the strategy may be to maximize revenue for players having a level (e.g., experience, score, or the like) above a selected threshold and maximize playtime for players having a level below a selected threshold.

For example, assume first and second consumers are playing the same electronic game having an available resource of a first weapon. Given a consumer profile 314 for the first consumer, which specifies the first consumer's location as moving across the Brooklyn Bridge, NYC at 9:00 A.M. on a Thursday, with an ambient temperature of 95 degrees at the first consumers location; as such, it may be assumed the first consumer is commuting and/or may not play long due to the temperature and/or arriving at a particular destination. Given a consumer profile 314 for the second consumer, which specifies the second consumer's location at a residence at 8:00 P.M. on a Thursday evening, with a playtime for the current session of over an hour and a historical playtime of over two hours each Thursday evening; as such, it may be assumed that the second consumer is at home, and will continue playing for another hour.

Furthermore, assume one of the strategy rules 312 specifies that if the consumer is expected to quit soon, then not to offer expensive and/or obtrusive advertisement resources, while another of the strategy rules 312 specifies that playtime should be maximized for players expected to quite soon, while another strategy rule 312 specifies that revue should be maximized. As such, the resource allocation system 160 may offer resources to the first consumer for free in order to maximize the playtime of the first consumer and offer resources to the second consumer for a cost, where that cost is greater than zero.

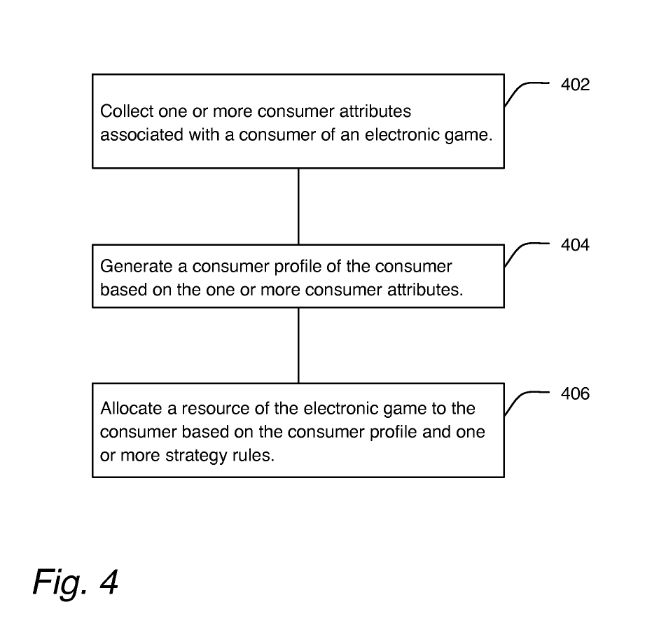

FIG. 4 is a flowchart of a method 400 for allocating resources in an electronic game environment. At step 402, collect one or more consumer attributes associated with a consumer of an electronic game. In an embodiment, the consumer attribute collection module 322 collects attributes associated with one or more consumers. The attributes may be either static and/or dynamic information, such as, for example, a time of day, location, a physical movement, an ambient temperature, a high score, an average length of play, a frequency of play, a distribution of play, or a proficiency of play.

At step 404, generate a consumer profile of the consumer based on the one or more consumer attributes. In an embodiment, the consumer profile compilation module 324 generates a consumer profile for each of the consumers. At step 406, allocate a resource of the electronic game to the consumer based on the consumer profile and one or more strategy rules. In an embodiment, the resource allocation module 326 allocates the available resources based on the strategy rules.

The exemplary systems and methods of this present invention have been described in relation to a gamer environment. However, to avoid unnecessarily obscuring the present invention, the preceding description omits a number of known structures and devices. This omission is not to be construed as a limitation of the scope of the claimed invention. Specific details are set forth to provide an understanding of the present invention. It should however be appreciated the present invention may be practiced in a variety of ways beyond the specific detail set forth herein.

Furthermore, while the exemplary embodiments of the present invention illustrated herein show the various components of the system collocated, certain components of the system can be located remotely, at distant portions of a distributed network, such as a LAN and/or the Internet, or within a dedicated system. Thus, it should be appreciated the components of the system can be combined into one or more devices, such as a switch, server, and/or adjunct, or collocated on a particular node of a distributed network, such as an analog and/or digital telecommunications network, a packet-switch network, or a circuit-switched network.

It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowchart has been discussed and illustrated in relation to a particular sequence of events, it should be appreciated that changes, additions, and omissions to this sequence can occur without materially affecting the operation of the present invention.

A number of variations and modifications of the present invention can be used. It would be possible to provide for some features of the present invention without providing others.

For example, in one alternative embodiment, the systems and methods of this present invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like.

In general, any device(s) or means capable of implementing the methodology illustrated herein can be used to implement the various aspects of this present invention. Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment of the present invention, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this present invention is dependent on the speed and/or efficiency requirements of the system, the particular function, and the particular software or hardware systems or microprocessor or microcomputer systems being utilized.

In yet another embodiment of the present invention, the disclosed methods may be partially implemented in software that can be stored on a storage medium, executed on programmed general-purpose computer with the cooperation of a controller and memory, a special purpose computer, a microprocessor, or the like. In these instances, the systems and methods of this present invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, the present invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the present invention has been presented for purposes of illustration and description. The foregoing is not intended to limit the present invention to the form or forms disclosed herein. In the foregoing Detailed Description for example, various features of the present invention are grouped together in one or more embodiments, configurations, or aspects for the purpose of streamlining the disclosure. The features of the embodiments, configurations, or aspects of the present invention may be combined in alternate embodiments, configurations, or aspects other than those discussed above. This method of disclosure is not to be interpreted as reflecting an intention the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A resource allocation system for optimizing the allocation of resources in electronic games, comprising:
a consumer attribute collection module configured to collect one or more consumer attributes associated with a consumer of an electronic game;
a consumer profile compilation module configured to describe the consumer by the one or more consumer attributes to produce a consumer profile; and
a resource allocation module configured to allocate a resource of the electronic game to the consumer based on the consumer profile and one or more strategy rules.

2. The resource allocation system of claim 1, wherein the one or more consumer attributes includes at least one of a location, a time of day, a physical movement, an ambient temperature, a high score, an average length of play, a frequency of play, a distribution of play, or a proficiency of play.

3. The resource allocation system of claim 1, wherein the consumer attribute collection module is configured to receive the one or more consumer attributes from a computing device associated with the consumer.

4. The resource allocation system of claim 1, wherein the consumer attribute collection module is configured to receive the one or more consumer attributes from a database.

5. The resource allocation system of claim 1, wherein the one or more consumer attributes includes a first consumer attribute and a second consumer attribute, the first consumer attribute being received from a computing device associated with the consumer and the second consumer attribute being received from a database.

6. The resource allocation system of claim 1, wherein the consumer is a first consumer, the consumer attribute collection module further configured to collect one or more second consumer attributes associated with a second consumer.

7. The resource allocation system of claim 6, wherein the consumer profile is a first consumer profile, the consumer profile compilation module further configured to describe the second consumer by the one or more second consumer attributes to produce a second consumer profile.

8. The resource allocation system of claim 7, wherein the resource is a first resource, the resource allocation module further configured to allocate a second resource to the second consumer based on the second consumer profile and the one or more strategy rules.

9. The resource allocation system of claim 8, wherein the first resource is allocated to the first consumer with a first associated cost and the second resource is allocated to the second consumer with a second associated cost.

10. The resource allocation system of claim 9, wherein the first resource and the second resource are the same.

11. The resource allocation system of claim 10, wherein the first associated cost and the second associated cost are different.

12. The resource allocation system of claim 8, wherein the first resource is different than the second resource.

13. A computer-implemented method of allocating resources for electronic games comprising:
collecting one or more consumer attributes associated with a consumer of an electronic game;
generating a consumer profile of the consumer based on the one or more consumer attributes; and
allocating a resource of the electronic game to the consumer based on the consumer profile and one or more strategy rules.

14. The computer-implemented method of claim 13, wherein the one or more consumer attributes includes at least one of a location, a time of day, a physical movement, an ambient temperature, a high score, an average length of play, a frequency of play, a distribution of play, or a proficiency of play.

15. The computer-implemented method of claim 13, wherein the one or more consumer attributes includes a first consumer attribute and a second consumer attribute, the method further comprising:
receiving the first consumer attribute from a computing device associated with the consumer; and
receiving the second consumer attribute from a database.

16. The computer-implemented method of claim 13, wherein the consumer is a first consumer, the consumer profile is a first consumer profile, the resource is a first resource, and the electronic game is a first electronic game, the method further comprising:
collecting one or more second consumer attributes associates with a second consumer;
generating a second consumer profile of the second consumer based on the one or more second consumer attributes; and
allocating a second resource of a second electronic game to the second consumer based on the second consumer profile and the one or more strategy rules.

17. The computer-implemented method of claim 16, wherein the first resource is allocated to the first consumer with a first associated cost and the second resource is allocated to the second consumer with a second associated cost.

18. The computer-implemented method of claim 17, wherein the first resource and the second resource are the same.

19. The computer-implemented method of claim 18, wherein the first associated cost and the second associated cost are different.

20. A computer readable medium storing computer readable instructions when executed by a processor perform a method comprising:
collecting one or more consumer attributes associated with a consumer of an electronic game;
generating a consumer profile of the consumer based on the one or more consumer attributes; and
allocating a resource of the electronic game to the consumer based on the consumer profile and one or more strategy rules.
